(19) United States
(12) Patent Application Publication
(10) Pub. No.: US 2023/0085723 A1
(43) Pub. Date: Mar. 23, 2023

(54) METHODS FOR ENHANCING PAGING OF A WIRELESS DEVICE OF A SET OR WIRELESS DEVICES, NETWORK NODES AND WIRELESS DEVICES USING RETRANSMISSION OF PAGES

(71) Applicant: Sony Group Corporation, Tokyo (JP)

(72) Inventors: Jose FLORDELIS, Lund (SE); Nafiseh MAZLOUM, Lund (SE); Fredrik RUSEK, Eslöv (SE); Johan HILL, Lund (SE)

(21) Appl. No.: 17/795,789

(22) PCT Filed: Jan. 13, 2021
(86) PCT No.: PCT/EP2021/050514

§ 371 Date: Jul. 27, 2022

(30) Foreign Application Priority Data
Feb. 13, 2020 (SE) 2050155-7

(51) Int. Cl. H04W 68/02

(52) U.S. Cl. CPC H04W 68/02

(57) ABSTRACT

Disclosed is a method, performed by a network node, for an enhanced paging of a wireless device of a set of wireless devices. The method comprises transmitting, to the set of wireless devices, information indicative of a first set of paging resources for first-time transmissions of paging data, and indicative of a second set of paging resources for retransmissions of the paging data. The second set of paging resources is different from the first set of paging resources. The method comprises transmitting, to the set of wireless devices, first-time transmissions of paging data using the first set of paging resources. The method comprises, upon detecting that at least one of the wireless devices of the set has failed to react to the first-time transmissions of paging data, transmitting, to the least one of the wireless devices, retransmissions of the paging data using the second set of paging resources.

The present disclosure pertains to the field of wireless communications. The present disclosure relates to methods for enhancing paging of a wireless device of a set of wireless devices, network nodes and wireless devices.

### BACKGROUND

A wireless device (such as a user equipment, UE) in Idle or Inactive mode (such as in RRC_IDLE/RRC_INACTIVE state where RRC stands for Radio Resource Control) needs to listen to paging on the cell it is camping on once every discontinuous reception, DRX, cycle at known paging occasions (POs), depending on the wireless device identifier (such as UE identity or UE identifier). Several wireless devices may be assigned the same POs; we refer to them as a paging group. The wireless device is paged when the network, e.g. the network node, wants to setup a connection, which may be due to a request from ongoing wireless device services or changes in the cell configuration. The wireless device checks for paging messages once every DRX cycle, typically 1.28 or 2.56 s. First, the wireless device checks for the presence of the so-called paging indicator for the paging group sent in the Physical Downlink Control Channel, PDCCH.

When the paging indicator is present for the wireless device, then the wireless device reads the paging message sent in the shared channel, Physical Downlink Shared Channel, PDSCH, in the same subframe, where it is indicated which wireless device in the paging group are actually paged. A wireless device being paged starts a random-access procedure at a predefined time and enters a connected mode (such as in RRC_CONNECTED state) to receive the data connected to the paging.

In order to save power, the hardware of the wireless device enters sleep whenever possible, especially in long DRX cycle. When the hardware of the wireless device is in sleep mode, most modem and hardware blocks (such as radio blocks including the high frequency clock) are switched off. Each time the wireless device needs to read the paging indicator, it takes time (e.g. substantially long time) to power on the hardware blocks so that the wireless device is ready to read the paging indicator.

There are some situations that still lead to an unnecessary power consumption for the wireless device related to paging.

### SUMMARY

The situations may occur due to a false wake-up for paging. For example, a false wake-up may occur when a wireless device successfully decodes the paging indicator and the paging message, only to discover that it is other wireless devices that are being paged. A false wake-up may be due to a missed paging. A missed paging may occur when the wireless device fails to receive a paging message, because for example either the paging indicator or the paging message could not be correctly decoded. When a missed paging occurs, the paging message is retransmitted by the network node at the next PO. In turn, paging retransmissions increase the probability of false wake-up of other wireless devices listening to the same PO.

There is a need to mitigate the probability of false wake-up due to missed paging by wireless devices.

Accordingly, there is a need for wireless devices, network nodes, and methods, for enhancing paging of a wireless device of a set of wireless devices which mitigate, alleviate or address the existing shortcomings and provide an enhanced paging process for retransmissions, which leads to reducing the unnecessary power consumption of the wireless device due to false wake ups.

Disclosed is a method, performed by a network node, for an enhanced paging of a wireless device of a set of wireless devices. The method comprises transmitting, to the set of wireless devices, information indicative of a first set of paging resources for first-time transmissions of paging data, and indicative of a second set of paging resources for retransmissions of the paging data. The second set of paging resources is different from the first set of paging resources. The method comprises transmitting, to the set of wireless devices, first-time transmissions of paging data using the first set of paging resources. The method comprises, upon detecting that at least one of the wireless devices of the set has failed to react to the first-time transmissions of paging data, transmitting, to the least one of the wireless devices, retransmissions of the paging data using the second set of paging resources.

Further, the present disclosure provides a network node comprising a memory circuitry, a processor circuitry, and a wireless interface. The network node is configured to perform any of the methods disclosed herein.

The disclosed method and network node allow an enhancement of the paging of the wireless device by reducing the probability of false wake-ups, and by reducing the time for retransmission of paging data.

Disclosed is a method performed by a wireless device, for an enhanced paging of the wireless device in idle mode. The method comprises receiving, from a network node, information indicative of a first set of paging resources for first-time transmissions of paging data, and indicative of a second set of paging resources for retransmissions of the paging data. The second set of paging resources is different from the first set of paging resources. The method comprises upon detecting that decoding of a first-time transmission of paging data has failed, monitoring for retransmissions of the paging data using the second set of paging resources.

Further, a wireless device is provided, the wireless device comprising a memory circuitry, a processor circuitry, and a wireless interface. The network node is configured to perform any of the methods disclosed herein.

It is an advantage of the present disclosure that the wireless device and the method disclosed herein leads to reduction of the power consumption occasioned by such false wake-ups and to an improved paging when retransmissions are necessary.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1A is a diagram illustrating an exemplary wireless communication system comprising an exemplary network node and an exemplary wireless device according to this disclosure,

FIG. 1B is a diagram illustrating example paging frames and example sets of paging resources according to the present disclosure,

FIG. 10 is a diagram illustrating example paging frames and example sets of paging resources according to the present disclosure,

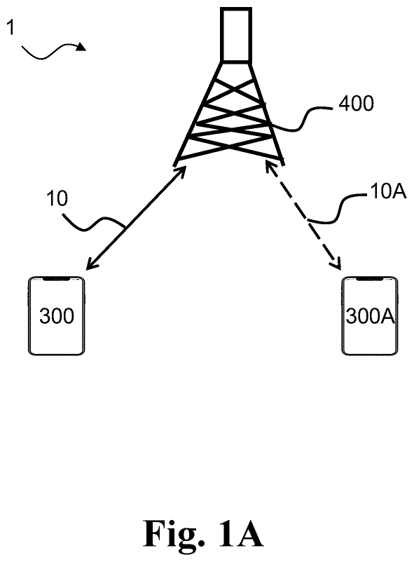

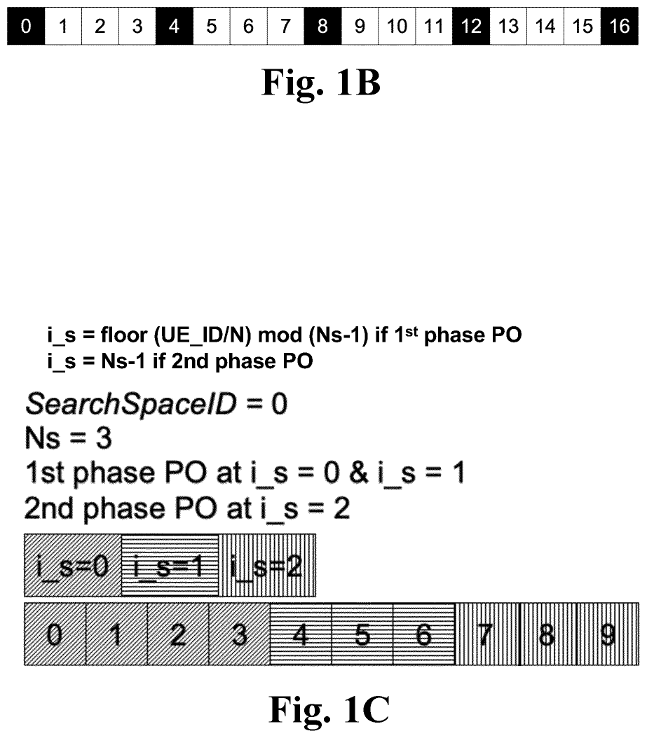

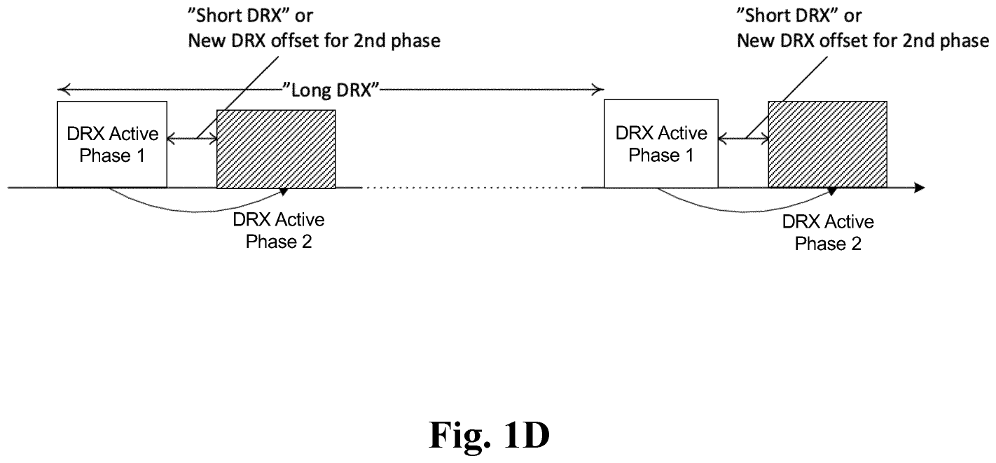

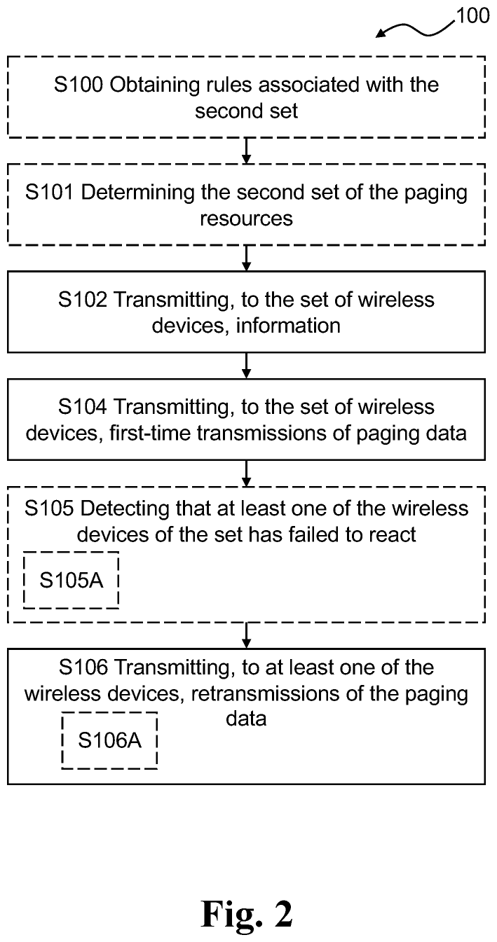

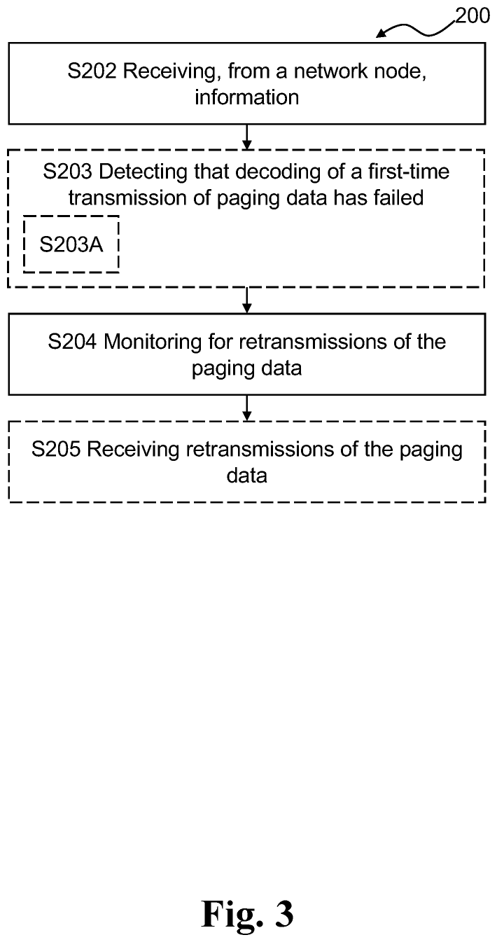

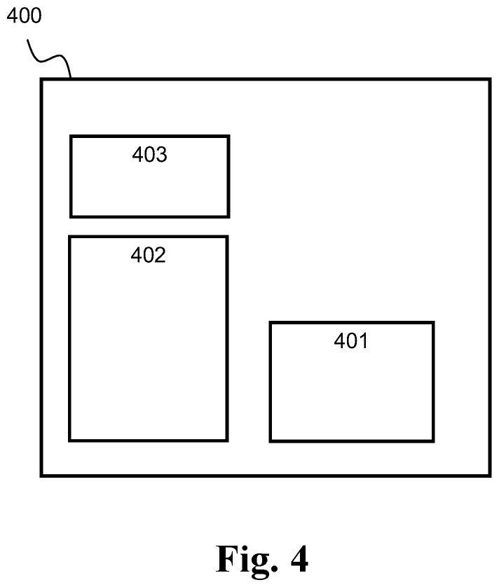

FIG. 1D is a diagram illustrating an example DRX cycle according to the present disclosure

FIG. 2 is a flow-chart illustrating an exemplary method, performed by a network node, for enhancing paging of a wireless device of a set of wireless devices according to this disclosure,

FIG. 3 is a flow-chart illustrating an exemplary method, performed by a wireless device of a wireless communication system, for enhancing paging according to this disclosure,

FIG. 4 is a block diagram illustrating an exemplary network node according to this disclosure,

FIG. 5 is a block diagram illustrating an exemplary wireless device according to this disclosure, and

FIG. 6 is a signalling diagram illustrating an example communication between example wireless devices, an example network node, and an example external node according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

In order to save power, the hardware of the wireless device enters sleep whenever possible. When the hardware of the wireless device is in sleep mode, most modem and radio blocks are switched off. The high frequency clock is turned off and just a minimum activity of the digital modem, clocked by a low frequency clock to restart the modem at the next paging occasion, is kept on. Each time the wireless device needs to read the paging indicator the high-frequency clock is turned on, frequency and timing are adjusted, and the radio is started to be able to receive paging. This takes relatively long time and power.

Especially when the wireless device must decode also the paging message.

The wireless device will wake up once every DRX cycle to check for paging messages. In an unfavourable scenario, a wireless device successfully decodes the paging indicator and the paging message, only to discover that it is other wireless devices that are being paged. This event is referred to as a false wake-up. Depending on the number of wireless devices camping on a cell and how DRX cycles are configured, the probability of false wake-up can be high. False wake-ups lead to increased wireless device power consumption.

A wireless device may fail to receive a paging message, because either the paging indicator or the paging message could not be correctly decoded. This event is referred to as a missed paging.

When a missed paging occurs, the paging message is retransmitted by the network node at the next PO. In turn, paging retransmissions increase the probability of false wake-up of other wireless devices listening to the same PO. The situation may be even more detrimental (e.g. worse), when a wireless device fails to decode paging retransmissions.

For example, the paging area is gradually extended from the initial camping cell, to a Tracking Area (TA), and to a Tracking Area List (TAL). A TAL can be a very large geographical area covering numerous cells. A missed paging of a wireless device can cause an increase of the false wake-up probability in other cells.

In 5G, the times of paging frames (PFs) and paging occasions (POs) wherein the wireless devices in RRC_IDLE state are to read the paging indicator and paging message are defined in TS 38.304. For example, the PFs occur at System Frame Numbers (SFNs) satisfying e.g.:

(SFN+P_Offset) mod T=(T div N)(UE_{ID} mod N),

where UE_ID=5G-S-TMSI mod 1024, T is the DRX cycle, PF_offset=1, . . . , T div N is the paging offset, and N is the number of PFs per DRX cycle.

Wireless devices are paged, and repetitions and resource mapping are set at a high level to avoid the paging miss rate to become higher. If a wireless device detects a paging decoding error, the wireless device waits until the next DRX cycle for its next opportunity. In new radio, NR, DRX cycles may be as long as 10.24 seconds. Therefore, a missed PO can significantly increase the time to paging of the wireless device.

An approach involving a wake up signal, WUS, may be used to mitigate the false wake-up issue. This is achieved by addressing WUSs to paging groups. While WUS can limit the number of devices that need to listen to paging at the same PO, it does not address false wake-up cost within a paging group due to a missed PO. All wireless devices within a paging group always read the paging indications and paging messages scheduled for their group.

It is therefore beneficial that wireless devices are able to decode and answer to the paging as early as possible in the paging process and to minimize false wake-ups. The present disclosure proposes a technique that permits an enhanced paging by mitigating the occurrences of false wake-up due to missed paging by wireless devices.

The present disclosure introduces, in one or more example embodiments, a second set of paging resources dedicated to retransmissions of the paging data (such as a second phase of Paging Occasions to be used) upon detecting that at least one of the wireless devices of the set has failed to react to the first-time transmissions of paging data (e.g. when decoding of the first PO has failed). For example, the wireless devices that failed to decode the paging indicator or the paging message using the first set of paging resources (such as the first phase) can in the present disclosure monitor the second set of paging resources (such as, listen to the second phase of paging). Other wireless devices may disregard the monitoring of the second set of paging resources.

The disclosed technique may benefit the wireless devices failing to decode a paging indicator and/or a paging message decoded (such as with CRC fail or paging PDSCH decoding fail, e.g. no matter if paging is for the wireless device or other wireless device in paging group). A latency or a time to connection is reduced, provided that the second set of paging resources is close in time to first set. The second set of paging resources may be provided with more resource elements and/or configured with more robust modulation and coding schemes (MCS), thereby improving chance for decoded paging data.

The disclosed technique may benefit the wireless devices with paging indicator and/or paging message decoded successfully (such as PDCCH cyclic redundancy check, CRC, and/or paging PDSCH decoded but not paged). For example, the wireless devices with paging indicator and/or paging message decoded successfully do no need to wake up again before next phase one DRX active period, at which time paging retransmissions may not be needed.

The second set of paging resources may not impact the wireless devices part of a PO group where the wireless devices have checked PDCCH CRC and successfully decoded PDSCH.

FIG. 1A is a diagram illustrating an exemplary wireless communication system 1 comprising an exemplary network node 400 and an exemplary wireless device 300 according to this disclosure.

As discussed in detail herein, the present disclosure relates to a wireless communication system 1 comprising a cellular system, e.g. a 3GPP wireless communication system. The wireless communication system 1 comprises a wireless device 300 and/or a network node 400.

A network node disclosed herein refers to a radio access network node operating in the radio access network, such as a base station, an evolved Node B, eNB, gNB.

The wireless communication system 1 described herein may comprise one or more wireless devices 300, 300A, and/or one or more network nodes 400, such as one or more of: a base station, an eNB, a gNB and/or an access point.

A wireless device may refer to a mobile device and/or a user equipment, UE.

The wireless devices 300, 300A may be configured to communicate with the network node 400 via a wireless link (or radio access link) 10, 10A.

FIG. 1B is a diagram illustrating an example paging frames according to the present disclosure. FIG. 1B shows the first set of paging resources corresponding paging frames 1, 2, 3 and the second set of paging resources dedicated to retransmissions of the paging data illustrated as paging frame 4.

The disclosed technique introduces, in one or more example embodiments, a second set of paging resources dedicated to retransmissions of the paging data illustrated as paging frames 4, 8, 12, 16 that may be used upon detecting that at least one of the wireless devices of the set has failed to react to the first-time transmissions of paging data.

Paging frames 4, 8, 12, 16 corresponding to the second sets of paging resources are multiplexed with paging frames corresponding to the first sets of paging resources, respectively: (1, 2, 3), (5, 6, 7), (9, 10, 11), and (13, 14, 15).

For example, FIG. 1B illustrates a multiplexing of the first set of paging resources and the second set of paging resources in time (such as on paging frame level). For example a set of offset values PF_Offset may be allocated for the wireless devices which fail to decode paging. For example, PF_Offset={1, 2, 3} denotes an offset paging frames for the first set of paging resources and PF_Offset={4} denotes an offset corresponding to paging frames the second set of paging resources. It may be envisaged to have a paging frame allocated in multiple radio frames.

The first set of paging resources may be derived by e.g.:

(SFN+PF_Offset₁ₛₜ) mod T=(T div N)(UE_{ID} mod N) (1)

The first set of paging resources may be derived by e.g.:

(SFN+PF_{Offset}_{_{2nd}}) mod T=(T div N)(UE_{ID} mod N) (2)

and PF_Offset₁ₛₜ≠PF_Offset_{2nd}.
where T is the DRX cycle, SFN is subframe number and PF offset1st is offset for the first set of paging resources, N is the number of paging frames per DRX cycle, UE_ID is a wireless device identifier. It may be appreciated that for the first set of paging resources, some wireless devices are to wake up to listen to paging whenever PF_Offset_1st=1, while other wireless devices are to wake up when PF_Offset_1st=2 and yet some other wireless devices when PF_Offset_1st=3.

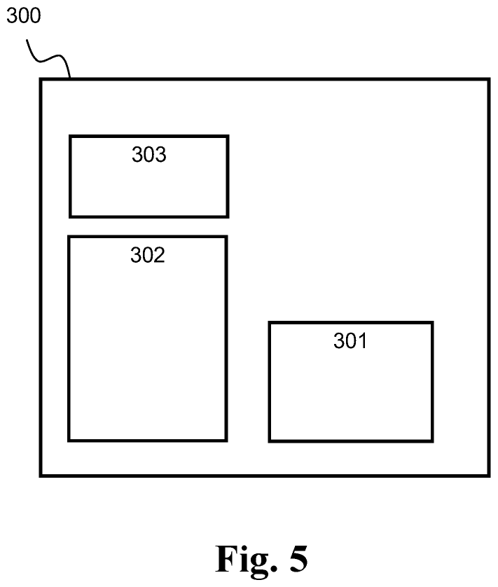

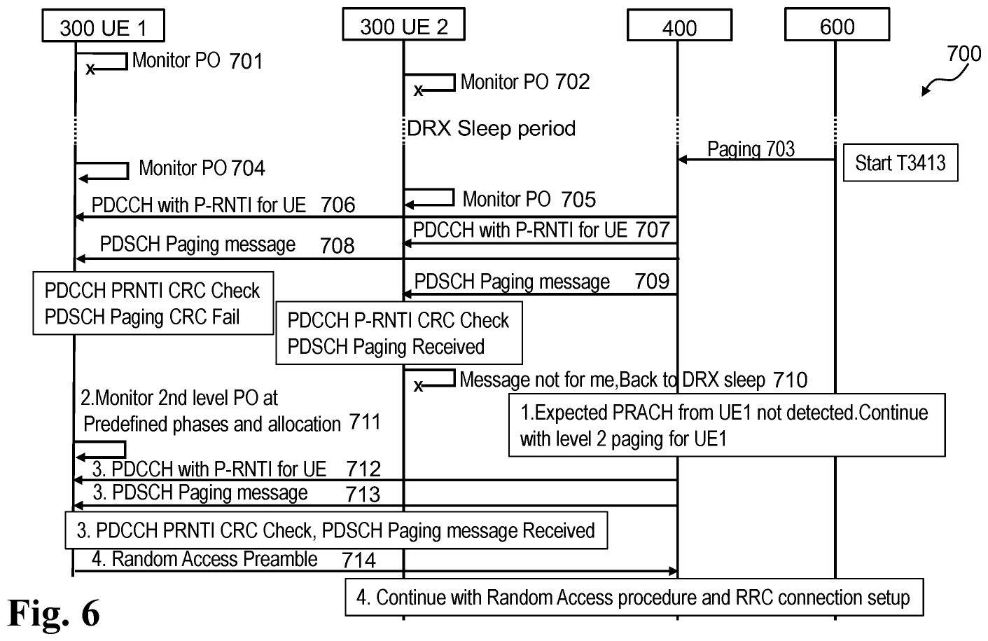

FIG. 10 is a diagram illustrating an example paging frame according to the present disclosure (e.g. paging occasion level). The second set of paging resources (7, 8, 9) is multiplexed in time with the first sets of paging resources (0, 1, 2, 3) and (4, 5, 6) with a time period, which may be seen as delay from the first set of paging resources and not in consecutive symbols/subframes. For example, the second set of paging resources may be delayed by a configured number of PF. A PF/PO may contain allocation from both 1^{st} set and the 2^{nd} set. An example for SearchSpaceID=0 with a larger Ns=3 can be seen in FIG. 10, where 1^{st} phase PO refers to the first set of paging resources, and 2^{nd} phase PO refers to the second set of paging resources. It is to be noted that paging occasions can have a slot granularity while paging frames have a radio frame granularity.

It is to be noted that SearchspaceID indicates whether the operation is done without beamforming (e.g. within Frequency Range 1, FR1) or with beamforming (e.g. within Frequency Range 2, FR2) and that SearchspaceID=0 indicates no beamforming and SearchspaceID as non-zero indicates beamforming. It is to be noted that i_s indicates potential paging occasions within a paging frame.

FIG. 1D is a diagram illustrating an example DRX cycle according to the present disclosure. The first set of paging resources are illustrated as DRX active phase 1. The second set of paging resources may be based on a second level DRX period. An already defined short DRX cycle may be reused or may define the 2nd set of paging resources (illustrated as 2^{nd} phase). The short cycle is only monitored when the wireless device fails to decode the first-time transmission of paging data in RRC Idle mode.

FIG. 2 shows a flow diagram of an exemplary method, performed by a network node, for an enhanced paging of a wireless device of a set of wireless devices. The set comprises one or more wireless devices. The one or more wireless devices may be in RRC-Idle mode. In some embodiments, it may be envisaged that the one or more wireless devices may be in RRC-connected mode.

The method 100 comprises transmitting S102, to the set of wireless devices, information indicative of a first set of paging resources for first-time transmissions of paging data, and indicative of a second set of paging resources for retransmissions of the paging data. Optionally, the paging data comprises a paging indicator and/or a paging message.

The second set of paging resources is different from the first set of paging resources. For example the information may be transmitted using control signalling. The control signalling comprises for example information indicative of the first set of paging resources for first-time transmissions of paging data and information indicative of the second set of paging resources. In one or more exemplary methods, the information indicative of the second set of paging resources is transmitted using system information. The system information comprises for example System Information Block, e.g. SIB, SIB1, e.g. other SIBs. In one or more exemplary methods, the information indicative of the second set of paging resources comprises a flag indicating the presence of the second set of paging resources. For example the flag may be seen as an implicit signalling of the second set of paging resources (such as an implicit indication of resources as time offset). For example, a flag indicating the presence of the second resource is transmitted in the SIB and the wireless device then determines the time/frequency using rules defined in the standard (e.g. Equation (2)) or signalled by RRC.

In one or more exemplary methods, the information indicative of the second set of paging resources comprises a resource indicator of the second set of paging resources. For example the resource indicator indicates explicitly the resource, such as time resource and/or frequency resource for the second set.

The first-time transmissions of paging data are for the first time transmissions for the set of wireless devices. The first-time transmissions of paging data refer to initial transmissions of paging data, e.g. corresponding to the first time the paging data is transmitted for the set of wireless devices. The first-time transmissions of paging data may be seen as the first occurrence of transmissions of paging data for the set of wireless devices.

The method 100 comprises transmitting S104, to the set of wireless devices, first-time transmissions of paging data using the first set of paging resources. In other words, first-time attempts to page the wireless devices are transmitted using the first set of paging resources.

The method 100 comprises, upon detecting that at least one of the wireless devices of the set has failed to react to the first-time transmissions of paging data, transmitting S106, to the least one of the wireless devices, retransmissions of the paging data using the second set of paging resources. For example, that a wireless device has failed to react implies that it is anticipated that the wireless device has not heard the paging and that the paging needs to be repeated. In other words, when a paging needs to be repeated, for any reason, the second set of paging resources is used. For example, the network node can detect that at least one of the wireless devices of the set has failed to react to the first-time transmissions of paging data by detecting that the at least one of the wireless devices of the set has not initiated a random access procedure. In one or more exemplary methods, the method comprises detecting S105 that at least one of the wireless devices of the set has failed to react to the first-time transmissions of paging data. In one or more exemplary methods, the detecting S105 comprises detecting S105A that the at least one of the wireless devices of the set has not initiated a random access procedure. For example, the network node can detect that the at least one of the wireless devices of the set has not initiated a random access procedure by failing to receive a Preamble RACH, PRACH.

The disclosed method may be seen as providing advantageously a hierarchical paging reducing false wake-ups. In other words, a hierarchy between the first set of paging resources and the second set of paging resources is introduced to enable paging data retransmissions which are earlier and reduce false wakeups.

In one or more exemplary methods, the first set of paging resources and the second set of paging resources are multiplexed in time. For example, the first set of paging resources and the second set of paging resources are multiplexed in time (e.g. according to paging frames which are in time) as illustrated in FIG. 1B. Stated differently, the first set of paging resources and the second set of paging resources are non-overlapping. Typically, they are scheduled on the same channel, for example on the same frequencies, but subsequent in time.

In one or more exemplary methods, the second set of paging resources comprises one or more paging resources which are offset in time from the first set of paging resources. For example, the second set of paging resources may be offset relative to the first set of paging resource, e.g. with a positive offset. The information indicative of the second set of paging resources for retransmissions of the paging data comprises for example, information indicative of the offset (e.g. a set of PF_Offset values allocated for UEs which fail to decode paging). The offset value may be expressed in paging frames. It may be that a paging frame is allocated in multiple radio frames. The second set of paging resources which are offset in time from the first set of paging resources may be consecutive in time to the first set of paging resources as illustrated in FIG. 1B.

In one or more exemplary methods, the second set of paging resources comprises one or more paging resources which are offset by a time period after the first set of paging resources within a paging frame. For example, there may be a time period between first set of paging resources and the second set paging resources.

In an initialization phase, such as a setup procedure (e.g. RRC configuration or connection setup), the network node may determine and/or configure the second set of paging resources indicated in S102. In one or more exemplary methods, the method comprises obtaining S100 rules associated with the determining of the second set of paging resources (e.g. with the offset). The rules may be obtained from a memory circuitry of the network node (e.g. hardcoded). The rules may be obtained from during initialization and RRC connection. Examples may be found in Equation (2). In one or more exemplary methods, the method comprises determining S101 the second set of the paging resources based on the obtained rules and the offset.

In one or more exemplary methods, the second set of paging resources comprises one or more paging resources associated with a short DRX cycle. For example, when configuring the second set of paging resources on paging frame level or paging occasion level, the network node configures, via RRC, one DRX configuration information with additional fields, as needed, to reserve resource for the second set of paging resources. The DRX cycle for the second set of paging resources may be shorter than the DRX associated with the first set of paging resources. This is for example illustrated in FIG. 1D.

In one or more exemplary methods, the second set of paging resources comprises more paging resources, for the least one of the wireless devices failing to react, than the first set. For example, the network node allocates more paging resources to the second set than the first to improve the reception and decoding at the at least one of wireless devices failing to react, e.g. needing the retransmission. For example, the second set may use more resource elements for the least one of the wireless devices failing to react, thereby improving chance for decoded paging message.

In one or more exemplary methods, transmitting S106, to the at least one of the wireless devices, retransmissions of the paging data using the second set of paging resources comprises transmitting S106A to the least one of the wireless devices, retransmissions of the paging data using a modulation and coding schemes that is more robust than for the first-time transmissions. For example, the second set may use a more robust modulation and coding scheme (MCS, e.g. higher-order MCS), thereby improving chance for decoded paging message.

FIG. 3 shows a flow diagram of an exemplary method performed by a wireless device, for an enhanced paging of the wireless device. The wireless device may be in idle mode and/or inactive mode (and optionally in connected mode). In principle, the wireless device may be in any pageable mode.

The method 200 comprises receiving S202, from a network node, information indicative of a first set of paging resources for first-time transmissions of paging data, and indicative of a second set of paging resources for retransmissions of the paging data. The second set of paging resources is different from the first set of paging resources. The wireless device receives in S202 the information transmitted by the network node in S102. The first and second sets of paging resources have already been explained above.

The method 200 comprises upon detecting that decoding of a first-time transmission of paging data has failed, monitoring S204 for retransmissions of the paging data using the second set of paging resources. In other words, detecting that a first-time transmission of paging data has failed means that the wireless device knows that paging data was transmitted, but that it has failed to read it and/or to react to it. For example, the wireless device monitors PDCCH for retransmissions of the paging data at the second set of paging resources (such as DCI over PDCCH, and the paging message over PDSCH).

In one or more exemplary methods, the method comprises detecting S203 that decoding of a first-time transmission of paging data has failed. For example, the detecting S203 comprises failing S203A to decode a first paging indicator and/or a first paging message.

In one or more exemplary methods, the method comprises receiving S205 retransmissions of the paging data over the second set of paging resources.

In one or more exemplary methods, the information indicative of the second set of paging resources is transmitted using system information. The system information comprises for example System Information Block, e.g. SIB, SIB1 or other SIBs.

In one or more exemplary methods, the information indicative of the second set of paging resources comprises a flag indicating the presence of the second set of paging resources. For example the flag may be seen as an implicit signalling of the second set of paging resources (such as an implicit indication of resources as time offset). For example, a flag indicating the presence of the second resource is transmitted in the SIB and the wireless device then determines the time/frequency using rules defined in the standard (e.g. Equation (2)) or signalled by RRC.

In one or more exemplary methods, the information indicative of the second set of paging resources comprises a resource indicator of the second set of paging resources. For example the resource indicator indicates explicitly the resource, such as time resource and/or frequency resource for the second set.

FIG. 4 shows a block diagram of an exemplary network node 400 according to the disclosure. The network node 400 comprises a memory circuitry 401, a processor circuitry 402, and a wireless interface 403. The network node 400 may be configured to perform any of the methods disclosed in FIG. 2. In other words, the network node 400 may be configured for enhancing paging of a wireless device of a set of wireless devices.

The network node 400 is configured to communicate with a wireless device, such as the wireless device disclosed herein, using a wireless communication system.

The network node 400 is configured to transmit (such as via the wireless interface 403) to the set of wireless devices, information indicative of a first set of paging resources for first-time transmissions of paging data, and indicative of a second set of paging resources for retransmissions of the paging data. The second set of paging resources may be different from the first set of paging resources.

The network node 400 is configured to transmit (such as via the wireless interface 403) to the set of wireless devices, first-time transmissions of paging data using the first set of paging resources.

The network node 400 is configured upon detecting that at least one of the wireless devices of the set has failed to react to the first-time transmissions of paging data, to transmit (such as via the wireless interface 403), to the least one of the wireless devices, retransmissions of the paging data using the second set of paging resources.

In one or more example network nodes, the first set of paging resources and the second set of paging resources are multiplexed in time.

In one or more example network nodes, the second set of paging resources comprises one or more paging resources which are offset in time from the first set of paging resources.

In one or more example network nodes, the second set of paging resources comprises one or more paging resources which are offset by a time period after the first set of paging resources.

In one or more example network nodes, the second set of paging resources comprises one or more paging resources associated with a short DRX cycle.

In one or more example network nodes, the second set of paging resources comprises more paging resources than the first set.

In one or more example network nodes, the paging data comprises a paging indicator and/or a paging message.

In one or more example network nodes, the information indicative of the second set of paging resources is transmitted using system information.

In one or more example network nodes, the information indicative of the second set of paging resources comprises a flag indicating the presence of the second set of paging resources.

In one or more example network nodes, the information indicative of the second set of paging resources comprises a resource indicator of the second set of paging resources.

The wireless interface 403 is configured for wireless communications via a wireless communication system, such as a 3GPP system, such as a 3GPP system supporting paging.

The network node 400 is optionally configured to perform any of the operations disclosed in FIG. 2 (such as any one or more of S100, S101, S105, S105A, S106A). The operations of the network node 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the network node 400 may be considered a method that the network node 400 is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 4). The memory circuitry 401 is considered a non-transitory computer readable medium.

The memory circuitry 401 may be configured to store information (such as information indicative of second set of paging resources) in a part of the memory.

FIG. 5 shows a block diagram of an exemplary wireless device 300 according to the disclosure. The wireless device 300 comprises a memory circuitry 301, a processor circuitry 302, and a wireless interface 303. The wireless device 300 may be configured to perform any of the methods disclosed in FIG. 3. In other words, the wireless device 300 may be configured for enhancing paging of a wireless device of a set of wireless devices. The wireless device 300 is configured to communicate with a network node, such as the wireless device disclosed herein, using a wireless communication system.

The wireless device 300 is configured to transmit (such as via the wireless interface 303) to the set of wireless devices, information indicative of a first set of paging resources for first-time transmissions of paging data, and indicative of a second set of paging resources for retransmissions of the paging data. The second set of paging resources is different from the first set of paging resources.

The wireless device 300 is configured to receive (such as via the wireless interface 303), from a network node, information indicative of a first set of paging resources for first-time transmissions of paging data, and indicative of a second set of paging resources for retransmissions of the paging data. The second set of paging resources may be different from the first set of paging resources.

The wireless device 300 is configured, upon detecting that decoding of a first-time transmission of paging data has failed, to monitor (for example using the processor circuitry 302) for retransmissions of the paging data using the second set of paging resources.

In one or more example wireless devices, the information indicative of the second set of paging resources is transmitted using system information.

In one or more example wireless devices, the information indicative of the second set of paging resources comprises a flag indicating the presence of the second set of paging resources.

In one or more example wireless devices, the information indicative of the second set of paging resources comprises a resource indicator of the second set of paging resources.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M.

The wireless device 300 is optionally configured to perform any of the operations disclosed in FIG. 3 (such as any one or more of S203, S203A, S205). The operations of the wireless device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the wireless device 300 may be considered a method that the wireless device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 5). The memory circuitry 301 is considered a non-transitory computer readable medium.

The memory circuitry 301 may be configured to store information (such as information indicative of second set of paging resources) in a part of the memory.

FIG. 6 is a signalling diagram 700 illustrating an example communication between example wireless devices 300, 300A, an example network node 400, and an example external node 600 according to this disclosure.

At a setup or initialisation phase, the wireless devices 300, 300A (such as UE1, UE2) and the network node 400 set-up the parameters necessary for retransmission: e.g. control signalling or information indicative of a first set of paging resources for first-time transmissions of paging data, and indicative of a second set of paging resources for retransmissions of the paging data. The second set of paging resources is different from the first set of paging resources.

The second set of resources may be seen as a second phase of paging occasion together with a 1st phase associate with the first set of paging resources. This can be by SIB1 or other SIBs message or control plane signalling on RRC level.

In FIG. 6, the wireless device 300 monitors for a paging occasion 701, which turns out not to be intended for wireless device 300.

The wireless device 300A monitors for a paging occasion 702, which turns out not to be intended for wireless device 300A. The wireless device 300A then enters (such as goes to) a DRX sleep period.

The external node 600 (for example mobility management entity, MME) requests the external node 400 (for example gNB) for paging 703.

The wireless device 300 monitors for a paging occasion 704, which turns out to be intended for wireless device 300.

The wireless device 300A monitors for a paging occasion 705, which turns out to be intended for wireless device 300A.

The wireless device 300 receives a paging indicator 706 for 300 (such as Paging-Radio Network Temporary Indicator, P-RNTI) over PDCCH from the network node 400. This corresponds to first-time transmission of paging data over a first set of paging resources.

The wireless device 300A receives a paging indicator 707 for 300A (such as Paging-Radio Network Temporary Indicator, P-RNTI) over PDCCH from the network node 400.

The wireless device 300 receives a paging message 708 for 300 (such as paging message) over PDSCH from the network node 400. This corresponds to first-time transmission of paging data over a first set of paging resources.

The wireless device 300A receives a paging message 709 for 300A (such as paging message) over PDSCH from the network node 400.

The wireless device 300 fails to decode the paging message 708 (such as fails to decode cyclic redundancy check, CRC) over PDSCH. The wireless device 300 may also fail to decode the paging indicator 706 (such as the P-RNTI) over PDCCH. In other words, the wireless device detects that decoding of a first-time transmission of paging data has failed.

The wireless device 300A succeeds to decode the paging message 709 (such as succeeds to decode cyclic redundancy check, CRC) over PDSCH and/or to decode the paging indicator 707 (such as the P-RNTI) over PDCCH. The wireless device 300A detects 710 that the paging message is not intended for the wireless device 300A and returns to sleep according to DRX.

Until 710, the signalling diagram may be seen as illustrating how two wireless devices 300, 300A in RRC Idle state monitor their scheduled paging occasion every DRX cycle. Wireless device 300 fails to read its paging DCI. Wireless device 300A successfully decodes the paging message 709 and finds out that the message 709 is intended for some other wireless devices.

The network node 400 expects to receive the preamble random access channel, PRACH from the wireless device 300. The network node 400 does not detect the preamble random access channel, PRACH from the wireless device 300. The network node 400 proceeds to transmitting, to the wireless device 300, retransmission of the paging data using the second set of paging resources. In other words, the network node 400 expects a random-access preamble (such as a first paging message) from the wireless device 300, but will not receive the random-access preamble, as the wireless device 300 failed to decode the paging data (e.g. paging CRC fail). In other words, the network node 400 re-schedules the wireless device 300 in the second set of paging resources (such as any 2^{nd} phase of paging occasion and/or paging frame) monitored by the wireless device 300.

The wireless device 300 monitors 711 for retransmission of the paging data using the second set of paging resources (such as monitors 2^{nd} level paging occasion at predefined phases and allocation). In other words, since the wireless device 300 failed the decoding of the monitored control channel, the wireless device 300 expects the paging data to be scheduled in the retransmission of the paging data using the second set of paging resources (such as using the 2^{nd} phase of paging frame and/or paging occasion). In other words, when the pre-configured second set of paging resources (such as 2^{nd} phase) is close in time, the wireless device 300 can stay awake, but when it is longer time before the 2^{nd} set of paging resources, the wireless device 300 may also enter sleep, as the wireless device 300 does in any other DRX sleep period.

The wireless device 300 receives a paging indicator 712 for 300 (such as Paging-Radio Network Temporary Indicator, P-RNTI) over PDCCH from the network node 400. This corresponds to first-time transmission of paging data over a second set of paging resources.

The wireless device 300 receives a paging message 713 for 300 (such as paging message) over PDSCH from the network node 400. This corresponds to retransmissions of paging data over a second set of paging resources.

The wireless device 300 succeeds to decode the paging message 713 (such as succeeds to decode cyclic redundancy check, CRC) over PDSCH and/or to decode the paging indicator 712 (such as the P-RNTI) over PDCCH (such as the wireless device 300 this time successfully decodes both paging DCI and paging message).

In other words, the wireless device detects that decoding of retransmitted paging data has succeeded. In other words, the wireless device 300 is paged again. For example, this time the network node 400 may have increased allocation of resource elements for the DCI message, such as by changing modulation and coding scheme modulation and coding scheme, MCS, or similar. For example, if the first-time transmission (such as 1^{st} phase) and retransmission (such as 2^{nd} phase) are close in time, it may be possible to combine the paging messages and consider the retransmission (2^{nd} phase) as a repetition of the first-time transmission (1^{st} phase), such as to increase a signal to noise ratio, SNR, and/or decoding probability.

The network node 400 receives a PRACH 714 from the wireless device 300.

The network node 400 proceeds with random access procedure and radio resource control, RRC setup. In other words, the network node 400 expects a random-access preamble (such as the first-time transmission, for example the first paging message), now from the retransmission (2^{nd} phase). In other words, since the wireless device 300 decoded the paging successfully and the wireless device 300 is the targeted device, the random-access procedure is triggered to start and starts by transmitting the preamble.

Embodiments of methods and products (network nodes and wireless devices) according to the disclosure are set out in the following items:

Item 1.A method, performed by a network node, for enhancing paging of a wireless device of a set of wireless devices, the method comprising:
transmitting (S102), to the set of wireless devices, information indicative of a first set of paging resources for first-time transmissions of paging data, and indicative of a second set of paging resources for retransmissions of the paging data, wherein the second set of paging resources is different from the first set of paging resources;
transmitting (S104), to the set of wireless devices, first-time transmissions of paging data using the first set of paging resources; and
upon detecting that at least one of the wireless devices of the set has failed to react to the first-time transmissions of paging data:
transmitting (S106), to the least one of the wireless devices, retransmissions of the paging data using the second set of paging resources.
   Item 2. The method according to item 1, wherein the first set of paging resources and the second set of paging resources are multiplexed in time.
   Item 3. The method according to any of the previous items, wherein the second set of paging resources comprises one or more paging resources which are offset in time from the first set of paging resources.
   Item 4. The method according to any of the previous items, wherein the second set of paging resources comprises one or more paging resources which are offset by a time period after the first set of paging resources.
   Item 5. The method according to any of the previous items, wherein the second set of paging resources comprises one or more paging resources associated with a short DRX cycle.
   Item 6. The method according to any of the previous items, wherein the second set of paging resources comprises more paging resources, for the least one of the wireless devices failing to react, than the first set.
   Item 7. The method according to any of the previous items, wherein transmitting (S106), to the least one of the wireless devices, retransmissions of the paging data using the second set of paging resources comprises transmitting (S106A) to the least one of the wireless devices, retransmissions of the paging data using a modulation and coding scheme that is more robust than for the first-time transmissions.
   Item 8. The method according to any of the previous items, the method comprising
detecting (S105) that at least one of the wireless devices of the set has failed to react to the first-time transmissions of paging data.
   Item 9. The method according to item 8, wherein the detecting (S105) comprises detecting (S105A) that the at least one of the wireless devices of the set has not initiated a random access procedure.
   Item 10. The method according to any of the previous items, wherein the paging data comprises a paging indicator and/or a paging message.
   Item 11. The method according to any of items 3-9, the method comprising:
obtaining (S100) rules associated with the second set of paging resources, and
determining (S101) the second set of the paging resources based on the obtained rules and the offset.
   Item 12. The method according to any of the previous items, wherein the information indicative of the second set of paging resources is transmitted using system information.
   Item 13. The method according to any of the previous items, wherein the information indicative of the second set of paging resources comprises a flag indicating the presence of the second set of paging resources.
   Item 14. The method according to any of the previous items, wherein the information indicative of the second set of paging resources comprises a resource indicator of the second set of paging resources.
   Item 15. A method, performed by a wireless device, for enhancing paging, the method comprising:
receiving (S202), from a network node, information indicative of a first set of paging resources for first-time transmissions of paging data, and indicative of a second set of paging resources for retransmissions of the paging data, wherein the second set of paging resources is different from the first set of paging resources; and
upon detecting that decoding of a first-time transmission of paging data has failed, monitoring (S204) for retransmissions of the paging data using the second set of paging resources.
   Item 16. The method according to item 15, the method comprising:
detecting (S203) that decoding of a first-time transmission of paging data has failed.
   Item 17. The method according to item 16, wherein the detecting (S203) comprises failing (S203A) to decode a first paging indicator and/or a first paging message.
   Item 18. The method according to any of items 15-17, the method comprising:
receiving (S205) retransmissions of the paging data over the second set of paging resources.
   Item 19. The method according to any of items 15-18, wherein the information indicative of the second set of paging resources is transmitted using system information.
   Item 20. The method according to any of items 15-19, wherein the information indicative of the second set of paging resources comprises a flag indicating the presence of the second set of paging resources.
   Item 21. The method according to any of items 15-20, wherein the information indicative of the second set of paging resources comprises a resource indicator of the second set of paging resources.
   Item 22. A wireless device comprising a memory circuitry, a processor circuitry, and a wireless interface, wherein the wireless device is configured to perform any of the methods according to any of items 15-21.
   Item 23. A network node comprising a memory circuitry, a processor circuitry, and a wireless interface, wherein the network node is configured to perform any of the methods according to any of items 1-14.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-6 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method, performed by a network node, for enhancing paging of a wireless device of a set of wireless devices, the method comprising:
transmitting, to the set of wireless devices, information indicative of a first set of paging resources for first-time transmissions of paging data, and indicative of a second set of paging resources for retransmissions of the paging data, wherein the second set of paging resources is different from the first set of paging resources;
transmitting, to the set of wireless devices, first-time transmissions of paging data using the first set of paging resources; and
upon detecting that at least one of the wireless devices of the set has failed to react to the first-time transmissions of paging data:
transmitting, to the least one of the wireless devices, retransmissions of the paging data using the second set of paging resources.

2. The method according to claim 1, wherein the first set of paging resources and the second set of paging resources are multiplexed in time.

3. The method according to claim 1, wherein the second set of paging resources comprises one or more paging resources which are offset in time from the first set of paging resources.

4. The method according to claim 1, wherein the second set of paging resources comprises one or more paging resources which are offset by a time period after the first set of paging resources.

5. The method according to claim 1, wherein the second set of paging resources comprises one or more paging resources associated with a short DRX cycle.

6. The method according to claim 1, wherein the second set of paging resources comprises more paging resources, for the least one of the wireless devices failing to react, than the first set.

7. The method according to claim 1, wherein transmitting, to the least one of the wireless devices, retransmissions of the paging data using the second set of paging resources comprises transmitting to the least one of the wireless devices, retransmissions of the paging data using a modulation and coding scheme that is more robust than for the first-time transmissions.

8. The method according to claim 1, the method comprising detecting that at least one of the wireless devices of the set has failed to react to the first-time transmissions of paging data.

9. The method according to claim 8, wherein the detecting-comprises detecting that the at least one of the wireless devices of the set has not initiated a random access procedure.

10. The method according to claim 1, wherein the paging data comprises a paging indicator and/or a paging message.

11. The method according to claim 3, the method comprising:
obtaining rules associated with the second set of paging resources, and
determining the second set of the paging resources based on the obtained rules and the offset.

12. The method according to claim 1, wherein the information indicative of the second set of paging resources is transmitted using system information.

13. The method according to claim 1, wherein the information indicative of the second set of paging resources comprises a flag indicating the presence of the second set of paging resources.

14. The method according to claim 1, wherein the information indicative of the second set of paging resources comprises a resource indicator of the second set of paging resources.

15. A method, performed by a wireless device, for enhancing paging, the method comprising:
receiving, from a network node, information indicative of a first set of paging resources for first-time transmissions of paging data, and indicative of a second set of paging resources for retransmissions of the paging data, wherein the second set of paging resources is different from the first set of paging resources; and
upon detecting that decoding of a first-time transmission of paging data has failed, monitoring for retransmissions of the paging data using the second set of paging resources.

16. The method according to claim 15, the method comprising: detecting that decoding of a first-time transmission of paging data has failed.

17. The method according to claim 16, wherein the detecting comprises failing to decode a first paging indicator and/or a first paging message.

18. The method according to claim 15, the method comprising: receiving retransmissions of the paging data over the second set of paging resources.

19. The method according to claim 15, wherein the information indicative of the second set of paging resources is transmitted using system information.

20. The method according to claim 15, wherein the information indicative of the second set of paging resources comprises a flag indicating the presence of the second set of paging resources.

21-23. (canceled)
